(19) United States
(12) Patent Application Publication
(10) Pub. No.: US 2013/0120374 A1
(43) Pub. Date: May 16, 2013

(54) IMAGE PROCESSING DEVICE, IMAGE PROCESSING METHOD, AND IMAGE PROCESSING PROGRAM

(71) Applicant: FUJIFILM CORPORATION, Tokyo (JP)

(72) Inventor: Hitoshi SAKURABU, Saitama-shi (JP)

(73) Assignee: FUJIFILM CORPORATION, Tokyo (JP)

(21) Appl. No.: 13/731,876

(22) Filed: Dec. 31, 2012

Related U.S. Application Data
(63) Continuation of application No. PCT/JP2011/003691, filed on Jun. 28, 2011.

(30) Foreign Application Priority Data
Jun. 30, 2010 (JP) 2010-148686

(51) Int. Cl. G06T 15/00

(52) U.S. Cl. CPC G06T 15/00
USPC 345/419

(57) ABSTRACT

A parallax amount between the plurality of images for each subject on the images is calculated, a subject is identified as a subject targeted for display position adjustment, in a case where the subject having an absolute parallax value which exceeds a predetermined amount is successively pictured in more than a predetermined number of frames, using a cross point provisionally set for the plurality of images as a reference, and parallax is adjusted such that the absolute parallax value of the subject targeted for display position adjustment does not exceed a predetermined amount after adjustment.

### TECHNICAL FIELD

The present invention relates to an image processing device and an image processing method for performing three-dimensional processing on a plurality of images with different viewpoints to enable stereoscopic viewing of the images, and for generating stereoscopic images which are stereoscopically displayed on a display means for stereoscopically display, as well as a program for causing a computer to carry out the three-dimensional processing method.

### BACKGROUND ART

Enabling stereoscopic viewing utilizing parallax by combining a plurality of images obtained by imaging the same subject from different positions such that stereoscopic images are generated, thereby stereoscopically displaying the generated stereoscopic image, is known. As a specific method for the stereoscopic display, a naked-eye parallel viewing method that stereoscopically displays images by arranging a plurality of images side by side is known. Further, the three-dimensional display may be achieved by combining images, for example, by overlapping the images while changing the colors of the images, such as into red and blue, or by overlapping the images while providing different polarization directions of the images. In these cases, the stereoscopic viewing can be achieved by using image separating glasses, such as red-and-blue glasses or polarization glasses, to provide a merged view of the images displayed for three-dimensional viewing (anaglyph system, polarization filter system).

Furthermore, stereoscopic viewing may be achieved by displaying images on a stereoscopic display monitor that enables stereoscopic viewing, such as that of a parallax barrier system or a lenticular system, without using polarization glasses, etc. In this case, stereoscopic viewing display is achieved by alternately arranging vertical strips of the images. Moreover, a method for providing a stereoscopic display using a residual image effect created by alternately and quickly displaying left and right images while changing directions of light beams from the left and right images by the use of image separation glasses or by attaching an optical element on a liquid crystal display has been proposed (scanning backlight system).

During stereoscopically display by the methods described above, it is necessary to appropriately adjust the stereoscopic effect of the stereoscopic images. This is because there has been a problem that a user will suffer from eye fatigue if a subject is located excessively far from the position of a cross point. Hence, there has been proposed a method of generating a stereoscopic image based on an appropriate parallax amount, which is judged for the stereoscopic image being stereoscopically displayed (see Japanese Unexamined Patent Publication No. 8 (1996)-223609, Japanese Unexamined Patent Publication No. 10 (1998)-048569, Japanese Unexamined Patent Publication No. 9 (1997)-218376 and Japanese Unexamined Patent Publication No. 8 (1996)-211332, which are hereinafter referred to as patent documents 1, 2, 3 and 4, respectively).

### DISCLOSURE OF THE INVENTION

However, every one of the devices of patent documents 1 through 3 detects a user's attention point for a stereoscopic image and appropriately controls the parallax of this attention point. In the case that a user places their attention point on a subject which is excessively far from a cross point position, this subject is focused on and thereby the user fixes his/her eyes on this subject, which fails to suppress the user's eyes fatigue. Note that in addition to the problems to be solved by the invention, there are problems that the configuration and control of the devices of patent documents 1 through 3 become complicated due to the necessity of a device for detecting an attention point.

Furthermore, the technique of patent document 4 appropriately controls parallax according to the arrangement of subjects in an image. In the case that changes of the arrangement of subjects in an image is considerable in the state of through-the-lens image, during video recording or video reproducing, the parallax is frequently adjusted, which results in causing a problem that the burden on users' eyes increases.

The present invention has been developed in view of the foregoing circumstances. It is an object of the present invention to appropriately adjust the stereoscopic effect of stereoscopic images.

The image processing apparatus according to the present invention sets a predetermined point which corresponds to each other within a plurality of images with different viewpoints as a cross point and generates a stereoscopic image which is stereoscopically displayed on a display means for stereoscopically display by performing a parallax adjustment on the plurality of images such that parallax becomes 0 at a position of a cross point, and is characterized by being equipped with: parallax amount calculation means for calculating a parallax amount among the plurality of images for each subject within the images; subject targeted for display position adjustment identifying means for identifying a subject as a subject targeted for display position adjustment, using a cross point provisionally set for the plurality of images as a reference in the case that a subject having an absolute parallax value which exceeds a predetermined amount is successively pictured in more than a predetermined number of frames; and parallax adjustment means for adjusting parallax such that the absolute parallax value of the subject targeted for display position adjustment does not exceed a predetermined amount after adjustment.

Note that health risks differ between stereoscopic display by a naked-eye viewing technique and stereoscopic display with a viewing technique that uses glasses, according to a parallax amount at near side or at back side. In the case of stereoscopically display by the naked-eye viewing technique, the more forward a subject is projected, a greater burden is put on users' eyes. In the case of the technique that uses glasses, the more backward a subject is retreated, a greater burden is put on users' eyes. Thus, it is necessary to decide an appropriate process according to the display technique.

In the image processing apparatus according to the invention, the predetermined amount is preferably 2.9% of a screen width, a comfortable viewing range for stereoscopically displaying, and more preferably 0.

Further, the predetermined number of frames is preferably no fewer than 3, nor more than 7, and more preferably 4 or 5.

The image processing apparatus according to the present invention may include image obtaining means for obtaining a plurality of images with different viewpoints, movement detecting means for detecting movement of the image obtaining means and control means for prohibiting the parallax adjustment means from adjusting parallax while the movement of the image obtaining means is detected.

In this case, the image processing apparatus according to the present invention further includes camera-shake detecting means for detecting a camera-shake amount of the image obtaining means. It is preferable for the camera-shake detecting means to function as the movement detecting means.

The image processing method according to the present invention sets a predetermined point which corresponds to each other within a plurality of images with different viewpoints as a cross point and generates a stereoscopic image which is stereoscopically displayed on display means for stereoscopically display by performing parallax adjustment on the plurality of images such that parallax becomes 0 at the position of the cross point, characterized by including: calculating a parallax amount among the plurality of images for each subject within the images; identifying a subject as a subject targeted for display position adjustment, using a cross point provisionally set for the plurality of images as a reference in the case that a subject having an absolute parallax value which exceeds a predetermined amount is successively pictured in more than a predetermined number of frames; and adjusting parallax such that the absolute parallax value of the subject targeted for display position adjustment does not exceed a predetermined amount after adjustment.

In the image processing method according to the present invention, it is preferable for movement of the image obtaining means to be detected when obtaining a plurality of image with different viewpoints by using an image obtaining means and for parallax adjustment to be ceased while the movement of the image obtaining means is detected.

The image processing method according to the present invention may be provided as program for causing a computer to carry out the method.

According to the present invention, parallax amounts among a plurality of images are calculated for each subject within the images. A subject is identified as a subject targeted for display position adjustment, using a cross point provisionally set for the plurality of images as a reference, in the case that a subject having an absolute parallax value which exceeds a predetermined amount is successively pictured in more than a predetermined number of frames. Then, parallax is adjusted such that the absolute parallax value of the subject targeted for display position adjustment does not exceed a predetermined amount after adjustment. Thereby, subjects, which are extremely far in a stereoscopically front-back direction from the cross point position, are eliminated such that the burden on users' eyes can be reduced. In this case, this process is carried out only when a subject having an absolute parallax value, which exceeds a predetermined amount, is successively pictured in more than a predetermined number of frames. This enables parallax adjustment not to be carried out with overreaction to subjects that slide past for just a moment, for example. Thereby, the burden on users' eyes can be reduced further.

Here, if the predetermined amount is 2.9% of a screen width, subjects that could impose excessive burden on the users' eyes can be eliminated, which can reduce the burden on users' eyes. In addition, if the predetermined amount is 0, a subject that is projected forward from a cross-point are eliminated, which can further reduce the burden on users' eyes.

Further, in the case that the predetermined number of frames is small, a cross-point position adjustment will be performed on, for example, subjects which just slide past for just a moment, due to excessive reaction thereto. This causes the users to feel discomfort. In contrast, in the case that the predetermined number of frames is large, cross-point position adjustments will rarely be performed even when subjects stay at expected positions, which increases the burden on the users' eyes. Hence, the predetermined number of frames is preferably no fewer than 3, nor more than 7, and more preferably 4 or 5.

Moreover, when obtaining a plurality of images with different viewpoints by using the image obtaining means, parallax adjustment is ceased while movement of the image obtaining means is detected, which enables prevention of rapid changes in the cross-point position when taking panning shots and the like, for example. This can reduce the burden on users' eyes.

In this case, if camera-shake amount detecting means (for example, gyro sensors) that the image obtaining means (for example, cameras) generally includes in recent years is also used as the movement detecting means for detecting movement of the image obtaining means, the present invention can be provided without adding new components.

### BRIEF DESCRIPTION OF THE DRAWINGS

FIG. 1 is a schematic block diagram that illustrates an internal configuration of a polynocular camera, to which an image processing apparatus according to a first embodiment of the present invention is applied,

FIG. 2 is a schematic block diagram that illustrates the internal configuration of an image processing apparatus according to a first embodiment of the present invention,

FIG. 3 is a schematic block diagram that illustrates the configuration of a three dimensional processing unit of the polynocular camera,

FIG. 4 is a flowchart that illustrates a process carried out at the time of adjusting a stereoscopic effect in the first embodiment,

FIG. 5 is a first diagram that illustrates a relationship between a position of each subject at the time of imaging and a parallax for each subject,

FIG. 6 is a diagram that illustrates an example of a display image after adjustment,

FIG. 7 is a diagram for explaining a timing of adjusting the stereoscopic effect,

FIG. 8 is a diagram for explaining a parallax adjustment in the case of a technique by using glasses,

FIG. 9 is a schematic block diagram that illustrates a three dimensional processing unit of a polynocular camera, to which an image processing apparatus according to a second embodiment of the present invention is applied,

FIG. 10 is a flow chart that illustrates a process carried out at the time of adjusting the stereoscopic effect in the second embodiment, and

FIG. 11 is a second diagram that illustrates a relationship between a position of each subject at the time of imaging and a parallax for each subject.

### BEST MODE FOR CARRYING OUT THE INVENTION

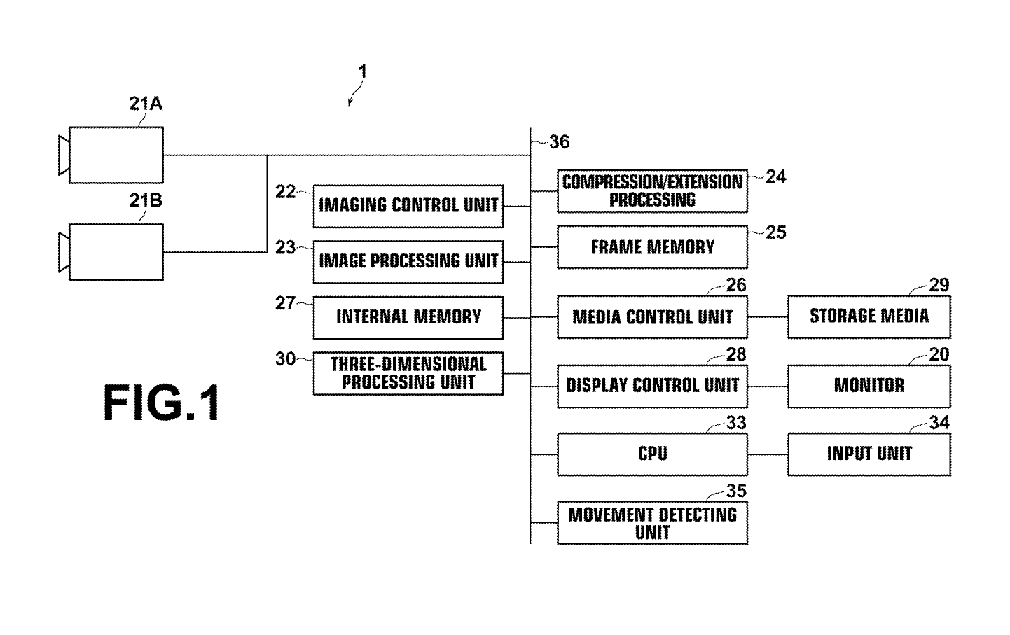

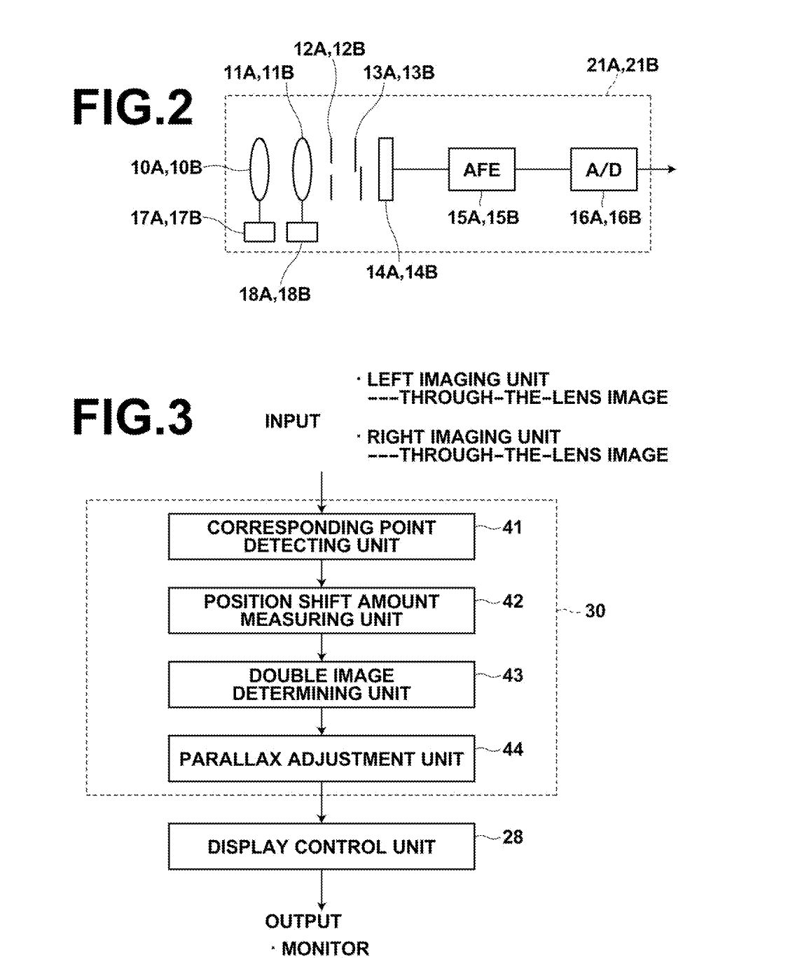

Hereinafter, embodiments of the present invention will be described with reference to the drawings. FIG. 1 is a schematic block diagram that illustrates the internal configuration of a polynocular camera, to which an image processing apparatus according to a first embodiment of the invention is applied. FIG. 2 is a schematic block diagram that illustrates the configuration of an imaging unit of the polynocular camera. FIG. 3 is a schematic block diagram that illustrates the configuration of a three dimensional processing unit of the polynocular camera.

As shown in FIG. 1, the polynocular camera 1 according to the first embodiment includes two imaging units 21A and 21B, a photographing control unit 22, an image processing unit 23, a compression/decompression unit 24, a frame memory 25, a media control unit 26, an internal memory 27, a display control unit 28, a three-dimensional processing unit 30, and a CPU 33. The imaging units 21A and 21B are placed to be able to photograph a subject with a predetermined baseline length and a convergence angle. It is assumed here that positions of the imaging units 21A and 21B in the vertical direction are the same. Further, a movement controlling unit 35 is not used in the first embodiment, but will be described later in a second embodiment.

FIG. 2 illustrates the configuration of the imaging units 21A and 21B. As shown in FIG. 2, the imaging units 21A and 21B include focusing lenses 10A and 10B, zooming lenses 11A and 11B, aperture diaphragms 12A and 12B, shutters 13A and 13B, CCDs 14A and 14B, analog front ends (AFE) 15A and 15B and A/D converting units 16A and 16B, respectively. The imaging units 21A and 21B further include focusing lens driving units 17A and 17B for driving the focusing lenses 10A and 10B and zooming lens driving units 18A and 18B for driving the zooming lenses 11A and 11B.

The focusing lenses 10A and 10B are used to focus on the subject, and are movable along the optical axis directions by the focusing lens driving units 17A and 17B, each of which is formed by a motor and a motor driver. The focusing lens driving units 17A and 17B control the movement of the focusing lenses 10A and 10B based on focal position data which is obtained through AF processing, which will be described later, carried out by the imaging control unit 22.

The zooming lenses 11A and 11B are used to achieve a zooming function, and are movable along the optical axis directions by the zooming lens driving units 18A and 18B, each of which is formed by a motor and a motor driver. The zooming lens driving units 18A and 18B control the movement of the zooming lenses 11A and 11B based on zoom data obtained at the CPU 33 upon operation of a zoom lever, which is included in an input unit 34.

The aperture diameters of the aperture diaphragms 12A and 12B are adjusted by an aperture diaphragm driving unit (not shown) based on aperture value data obtained through AE processing carried out by the imaging control unit 22.

The shutters 13A and 13B are mechanical shutters, and are driven by a shutter driving unit (not shown) according to a shutter speed obtained through the AE processing.

Each of the CCDs 14A and 14B includes a photoelectric surface, on which a large number of light-receiving elements are arranged two-dimensionally. A light image of the subject is focused on each photoelectric surface and is subjected to photoelectric conversion to obtain an analog imaging signal. Further, a color filter formed by regularly arrayed R, G and B color filters are disposed on the front side of each CCD 14A, 145.

The AFEs 15A and 15B process the analog imaging signals fed from the CCDs 14A and 14B to remove noise from the analog imaging signals and adjust the gain of the analog imaging signals (this operation is hereinafter referred to as “analog processing”).

The A/D converting units 16A and 16B convert the analog imaging signals, which have been subjected to the analog processing by the As 15A and 15B, into digital imaging signals. The images represented by digital image data acquired by the imaging units 21A and 21B are referred to as an image GL and an image GR, respectively.

The imaging control unit 22 includes an AF processing unit and an AE processing unit (not shown). When a release button included in the input unit 34 is half-pressed, the imaging units 21A and 21B acquire preliminary images. Then, the AF processing unit determines focused areas and focal distances for the lenses 10A and 10B based on the preliminary images, and outputs the information to the imaging units 21A and 21B. The AE processing unit determines an exposure value based on a brightness evaluation value, which is calculated from brightness values of the preliminary images, and further determines an aperture value and shutter speed based on the exposure value to output the information to the imaging units 21A and 21B.

When the release button is fully pressed, the imaging control unit 22 instructs the imaging units 21A and 21B to carry out actual imaging to acquire actual images of the images GL and GR. It should be noted that, before the release button is operated, the imaging control unit 22 instructs the imaging units 21A and 21B to successively acquire live view images at a predetermined time interval (for example, at an interval of 1/30 seconds) for checking imaging ranges of the imaging units 21A and 21B.

The image processing unit 23 administers image processing, such as white balance adjustment, tone correction, sharpness correction and color correction, to the digital image data of the images GL and G2 acquired by the imaging units 21A and 21B. In this description, the first and second images which have been processed by the image processing unit 23 are also denoted by the same reference symbols G1 and GR used for the unprocessed first and second images.

The compression/decompression processing unit 24 administers compression processing according to a certain compression format, such as JPEG, to the image data representing a three-dimensional image for three-dimensional display, which is generated, as will be described later, from the actual images of the images GL and GR processed by the image processing unit 23, and generates a three-dimensional image file for three-dimensional display. The three-dimensional image file contains the image data of the images GL and GR and the image data of the three-dimensional image. A tag storing associated information, such as photographing time and date, is added to the image file, based, for example, on the Exif format.

The frame memory 25 provides a workspace for various processes, including the processing by the image processing unit 23, administered to the image data representing the images GL and GR acquired by the imaging units 21A and 21B.

The media control unit 26 accesses a recording medium 29 and controls writing and reading of the three-dimensional image file, etc., into and from the recording medium 29.

The internal memory 27 stores various constants to be set within the polynocular camera 1, a program executed by the CPU 33, etc.

The display control unit 28 causes the images GL and GR stored in the frame memory 25 during imaging to be displayed for two-dimensional viewing on the monitor 20, or causes the images GL and GR recorded in the recording medium 29 to be displayed for two-dimensional viewing on the monitor 20. Further, the display control unit 28 can cause the images GL and GR, which have been subjected to three-dimensional processing, as will be described later, to be displayed for three-dimensional viewing on the monitor 20, or can cause the three-dimensional image recorded in the recording medium 29 to be displayed for three-dimensional viewing on the monitor 20. Switching between the two-dimensional display and the three-dimensional display may be carried out automatically, or may be carried out according to instructions from the photographer received via the input unit 34. During the three-dimensional display, live view images of the images GL and GR are displayed for three-dimensional viewing on the monitor 20 until the release button is pressed.

The three-dimensional processing unit 30 applies the three-dimensional processing to the images GR and GL for the three-dimensional display of the images GR and GL on the monitor 20. The three-dimensional display technique used in this embodiment may be any known technique. For example, the images GR and GL may be displayed side by side to achieve stereoscopic viewing by parallel viewing with naked eyes, or a lenticular system may be used to achieve the three-dimensional display, in which a lenticular lens is attached on the monitor 20, and the images GR and GL are displayed at predetermined positions on the display surface of the monitor 20 so that the images GR and GL are respectively viewed by the left and right eyes. Further, a scanning backlight system may be used, which achieves the three-dimensional display by optically separating the optical paths of the backlight of the monitor 20 correspondingly to the left and right eyes in an alternate manner, and alternately displaying the images GR and GL on the display surface of the monitor 20 according to the separation of the backlight to the left or the right.

The monitor 20 is modified according to the type of the three-dimensional processing carried out by the three-dimensional processing unit 30. For example, if the three-dimensional display is implemented with a lenticular system, a lenticular lens is attached on the display surface of the monitor 20. If the three-dimensional display is implemented with a scanning backlight system, an optical element for changing the directions of the light beams from the left and right images is attached on the display surface of the monitor 20.

It should be noted that in the description of the preferred embodiments, the case where a lenticular system (a naked-eye viewing technique) is adopted as a stereoscopic display technique will be described.

Accordingly, the three-dimensional processing unit 30 sets a predetermined point within each of the images GR, GL as a cross point and performs a process for cutting out a display range on the monitor 20 from the images GL and GR such that the cross points within the respective images GR, GL are displayed at the same position on the monitor 20, in order to three dimensionally display the images GR, GL on the monitor 20.

As shown in FIG. 3, the three-dimensional processing unit 30 includes a corresponding point detecting unit 40, a position shift amount measuring unit 42, a double image determining unit 43 and a parallax adjustment unit 44. The corresponding point detecting unit 41 detects a feature point from either one of the images GR, GL and detects a corresponding point from the other image, which corresponds to the feature point in the one image. The position shift amount measuring unit 42 performs a process for measuring a shift amount between each feature point and a corresponding point corresponding thereto. The double image determining unit 43 determines whether a subject is one to be projected forward from the cross point or one to be moved backward from the cross point. The parallax adjustment unit 44 adjusts the parallax of each subject by controlling a position at which a display range is cut out from the images GR, GL.

The CPU 33 controls the various units of the polynocular camera 1 according to signals inputted via the input unit 34, which includes the release button, the arrow key, etc.

The data bus 36 is connected to the various units forming the polynocular camera 1 and the CPU 33 for communication of various data and information in the polynocular camera 1.

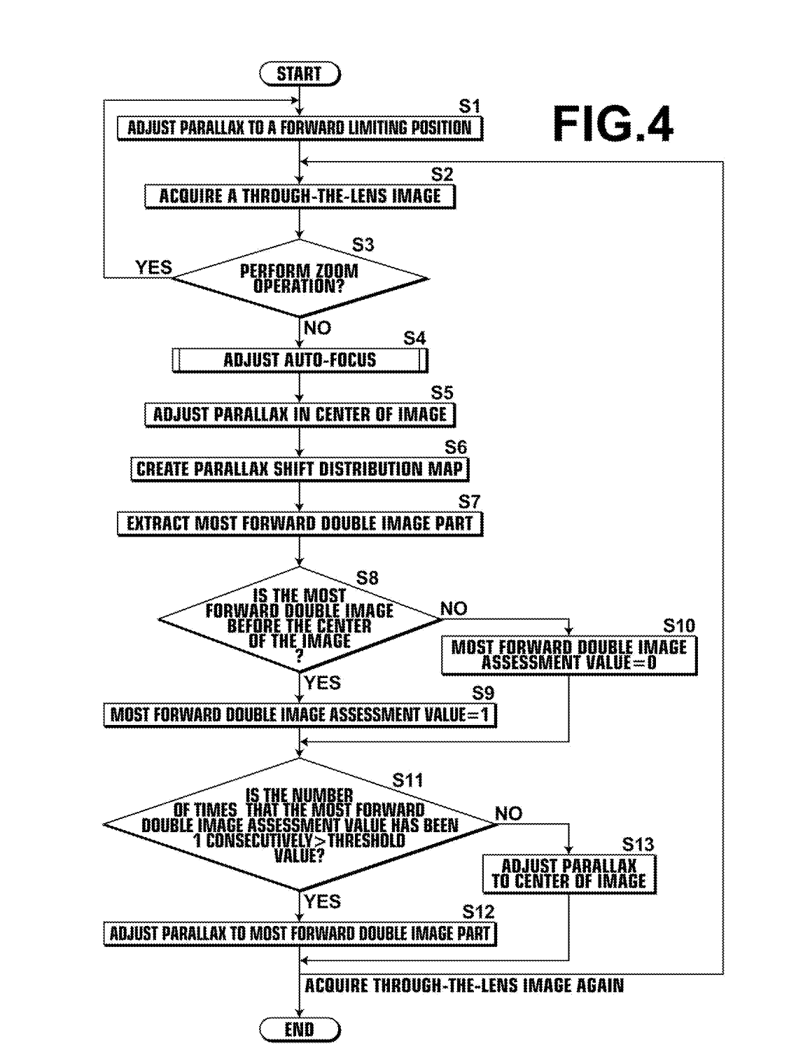

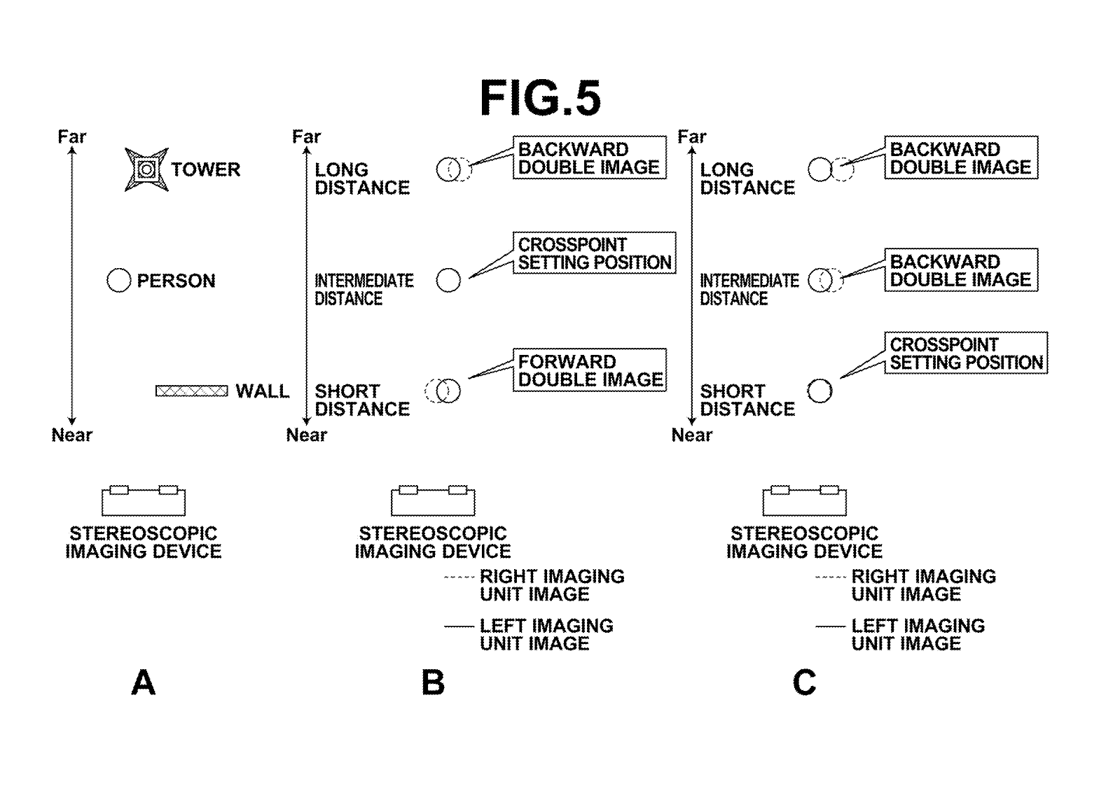

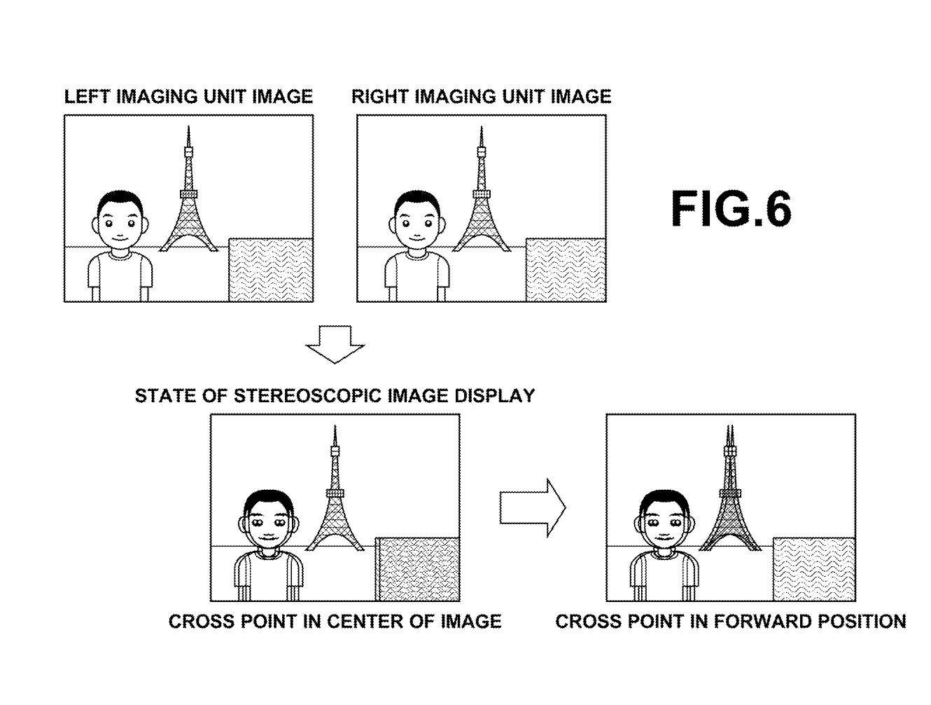

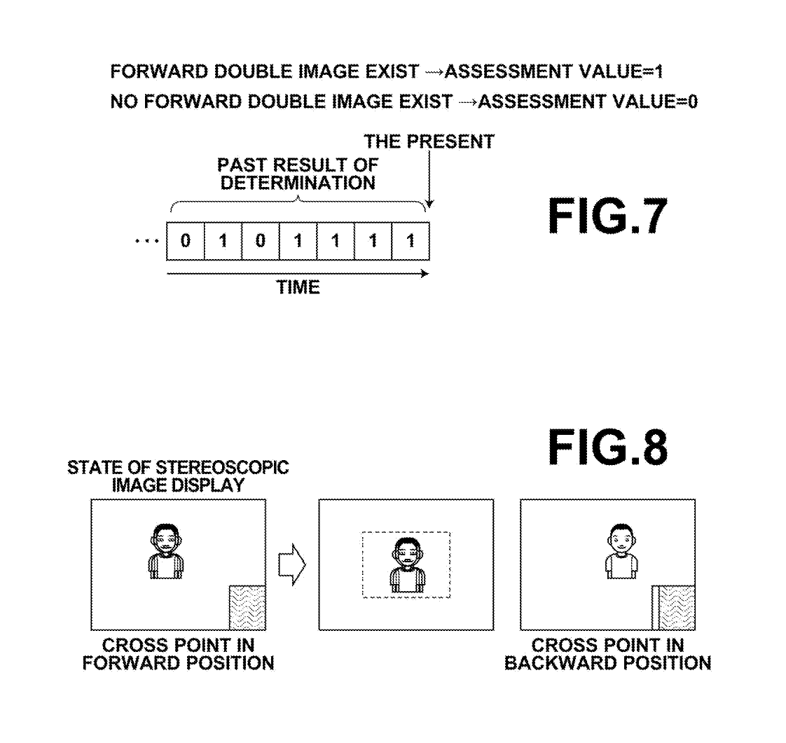

Next, a process carried out in the first embodiment will be described. FIG. 4 is a flow chart that illustrates the process carried out at the time of adjusting a stereoscopic effect in the first embodiment. FIG. 5 is a first diagram that illustrates a relationship between a position of each subject at the time of shooting and parallax for each subject. FIG. 6 is a diagram that illustrates an example of a display image after adjustment. FIG. 7 is a diagram for explaining a timing of adjusting the stereoscopic effect. FIG. 8 is a diagram for explaining a parallax adjustment in the case of a technique that uses glasses.

The case of displaying stereoscopic images of through-the-lens images will be described here. The same applies to the case of displaying live view images and still images on the monitor 20. First, a parallax adjustment is performed by adjusting the position of a cross point to a forward limiting position (step S1). Then, two images GR, GL (through-the-lens images) for generating stereoscopic images are obtained (step S2).

Next, a determination process is carried out to determine whether a zoom operation is being performed with respect to the imaging units 21A and 21B (step S3). If the result of the determination is affirmative, the process returns to step S1 to start over again. If the result of the determination is negative in step S3, a focusing operation is performed with respect to the imaging units 21A and 21B (step S4). As shown in FIG. 5, a parallax adjustment is performed by using either one of the two images GR, GL as a reference to set the center of a reference image as a provisional cross-point position (step S5).

Next, a parallax shift distribution map is generated (step S6), and a subject at the most forward position is identified (step S7). Then, a determination is made as to whether the subject at the most forward position is nearer than the subject at the center of the reference image (step S8). If the result of the determination is affirmative, “1” is obtained as a determination value for the most forward double image (step S9). If the result of the determination is negative, “0” is obtained as a determination value for the most forward double image (step S10).

Then, a determination is made as to whether the frequency of continuous appearance of “1”, which is obtained as a determination value for the most forward double image, exceeds a predetermined threshold value (step S11). As shown in FIG. 6, if the determination is affirmative, a parallax adjustment using the most forward double image as a cross point position, e.g., a process for preventing the subject from projecting forward from a cross point position (step S12). It should be noted that this is not limited only to the above, and a process such that the parallax amount of the most forward double image does not exceed 2.9% of a screen width, which is a comfortable viewing range for stereoscopic display, may be carried out. If the result of the determination in step S11 is negative, a parallax adjustment using the center of the reference image as a cross point position is performed (step S13).

After step S12 or step S13, as long as a state of being through-the-lens image continues, the process returns to step S2 to repeat the above process Note that this processing loop is carried out for each frame.

The determination in step S11 will never be affirmative in the first process. However, as shown in FIG. 7, if the above processing loop is repeated, the frequency of continuous appearance of “1”, which is a determination value for the most forward double image, could exceed the predetermined threshold value, i.e., a subject at not less than a predetermined distance forward from a provisional cross point position on an image could be continuously pictured in more than a predetermined number of frames.

In this case, if the predetermined number of frames is too small, a cross-point position adjustment will be performed on, for example, subjects that just slide past for just a moment, due to excessive reaction thereto. This causes users to feel discomfort. By contrast, if the predetermined number of frames is too large, a cross-point position adjustment is rarely performed even when subjects stay forward from the cross point position, which increases the burden on the users' eyes. Hence, a predetermined number of frames is preferably no fewer than 3, nor more than 7, and more preferably 4 or 5. This embodiment is described assuming that the number of frames is set to 4.

As shown in FIG. 7, if it is detected that the frequency of continuous appearance of “1” as the determining value for the most forward double image exceeds the threshold value, 3 (i.e., the fourth in a row is detected), a parallax adjustment is performed by setting the most forward double image as a cross point position.

According to the above structure, the stereoscopic effect of the stereoscopic images can be appropriately adjusted. In this case, this process is carried out only in the case that a subject having an absolute parallax value, which exceeds a predetermined amount, is successively pictured in more than a predetermined number of frames. This enables a parallax adjustment not to be carried out with overreaction to subjects that slide past for just a moment, for example. Thereby, the burden on users' eyes can be reduced further.

It should be noted that in the above embodiment, the a where a lenticular system (a naked-eye viewing technique) is adopted as a stereoscopic display technique is described. Health risks differ between stereoscopic display by a naked-eye viewing technique and stereoscopic display with a technique that uses glasses, according to the parallax amount at near side or at back side. In the case of the technique that uses glasses, the more backward a subject is retreated, the more burden is put on users' eyes. In this case, as shown in FIG. 8, a parallax adjustment may be performed by setting the most backward double image as a cross point position.

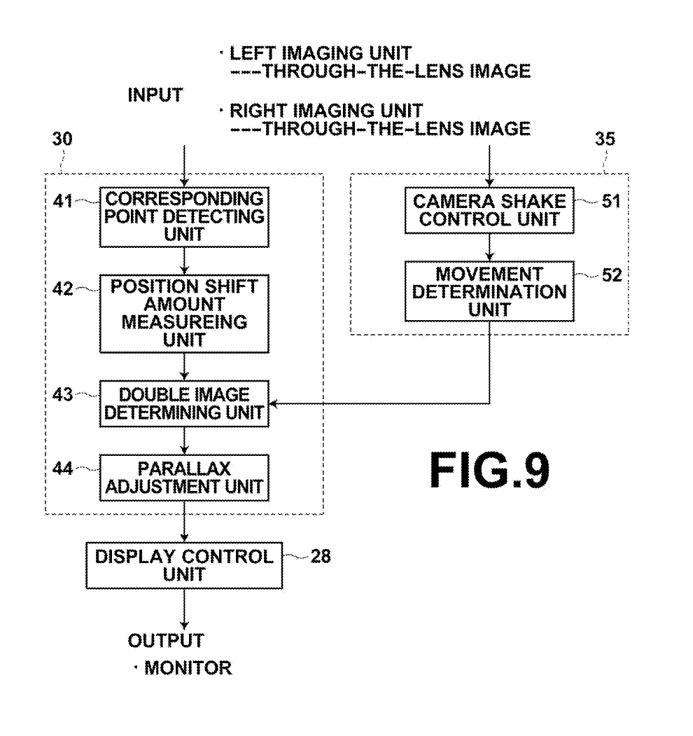

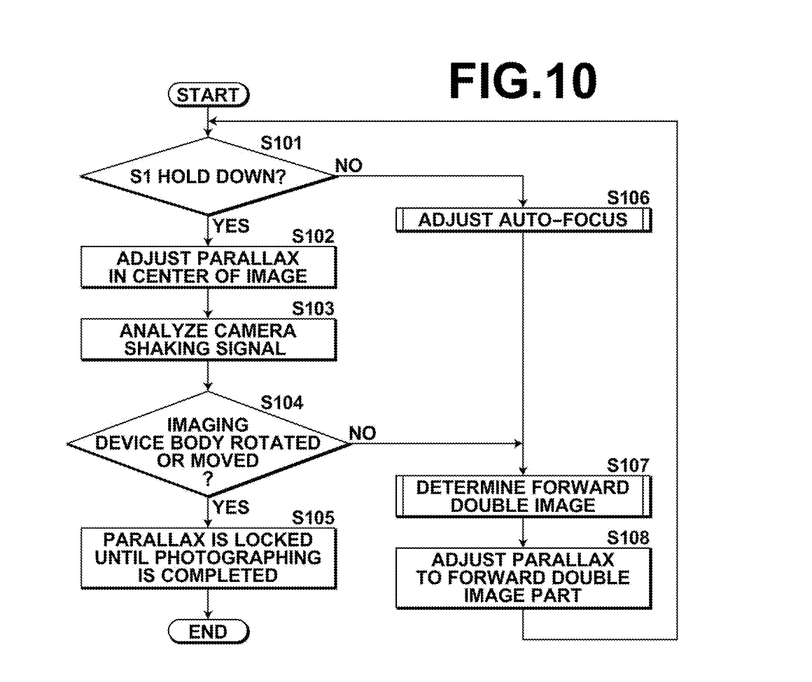

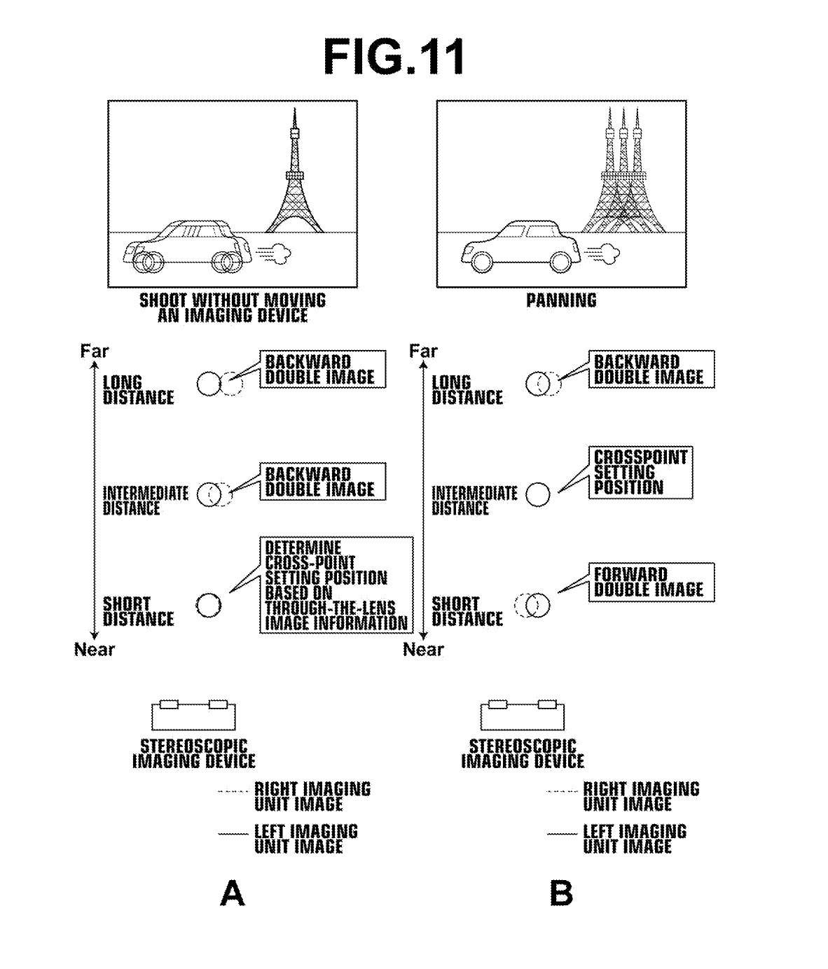

Next, the second embodiment of the present invention will be described. It should be noted that a polynocular camera, to which an image processing apparatus according to the second embodiment of the invention is applied, has substantially the same configuration as that of a polynocular camera 1 according to the first embodiment, and therefore detailed descriptions of the same constituent elements will be omitted here. FIG. 9 is a schematic block diagram that illustrates the configuration of a three-dimensional processing unit of a polynocular camera, to which an image processing apparatus according to the second embodiment of the present invention is applied. FIG. 10 is a flow chart that illustrates a process carried out at the time of adjusting the stereoscopic effect in the second embodiment, and FIG. 11 is a second diagram that illustrates a relationship between a position of each subject at the time of imaging and a parallax for each subject.

In the first embodiment described above, a parallax adjustment is automatically performed on the forward double image. However, if a moving subject is traced to be photographed (imaging while panning) in this manner, a distance relationship between the imaging units 21A, 21B and the subject sequentially changes so that parallax adjustments are frequently performed, which is likely to impose a burden on users' eyes. Therefore, a polynocular camera according to the second embodiment is designed to prevent a cross-point position from rapidly changing in the case of panning and the like, and differs in that it uses a movement control unit, compared to the polynocular camera according to the first embodiment.

As shown in FIG. 9, the three-dimensional processing unit 30 includes a corresponding point detecting unit 41, a position shift amount measuring unit 42, a double image determining unit 43 and a parallax adjustment unit 44. The corresponding point detecting unit 41 detects a feature point from either one of the images GR, GL and detects a corresponding point from the other image, which corresponds to the feature point in the one image. The position shift amount measuring unit 42 performs a process for measuring a shift amount between each feature point and a corresponding point corresponding thereto. The double image determining unit 43 determines whether a subject is one to be projected forward from the cross point or one to be moved backward from the cross point. The parallax adjustment unit 44 adjusts the parallax of each subject by controlling a position at which a display range is cut out from the images GR, GL.

Further, a movement detecting unit 35 includes a camera shake control unit 51 and a movement determination unit 52. The camera shake control unit 51 performs camera-shake correction with respect to the imaging units 21A and 21B, and has a gyro sensor for detecting a camera-shake amount of the imaging units 21A and 21B. The movement determination unit 52 receives a signal sent from the gyro sensor to detect movement of the imaging units 21A and 21B.

Next, a process carried out in the second embodiment will be described.

Here, a process in the case where a panning may be carried out is described. In this embodiment, as shown in FIG. 11, a cross-point position adjustment process differs during photography of normal live view images, still images and through-the-lens images or during panning.

First, a determination is made as to whether a moving image photographing start button (S1), which is not shown, is pressed (step S101). If the result of the determination is negative, an autofocus adjustment is performed (S106), a forward double image determination is performed (S107), a parallax adjustment is performed such that a forward double image is set as a cross-point position (S108), and the process returns to step S101.

If the determination in step S101 is affirmative, a parallax adjustment is performed by using either one of two images GR, GL as a reference to set the center of the reference image as a provisional cross-point position (step S102), and then the analysis is carried out on camera-shake signals at the camera shake control unit 51 (step S103).

Next, the determination is made as to whether a movement of the imaging units 21A and 21B is detected (step S104). If the determination is affirmative, a parallax is fixed until the panning is completed and the process is terminated.

If the determination in step S104 is affirmative, the process moves to S107 to repeat the processing loop.

Even when the above configuration is adopted, the same advantageous effects as those obtained by the first embodiment described above can be obtained, and even when the panning is performed, appropriate processing can be carried out.

Two embodiments of the invention have been described. In addition, the invention may be implemented as a program for causing a computer to function as means corresponding to the three-dimensional processing unit 30 described above to carry out the process in each embodiment. The invention may also be implemented as a computer-readable recording medium containing such a program.

Further, the image processing apparatus according to the invention is not limited to application in polynocular cameras, but may be applied to any other apparatus such as an image display device.

What is claimed is:

1. An image processing apparatus that sets a predetermined point which corresponds to each of a plurality of images with different viewpoints, as a cross point and generates a stereoscopic image which is stereoscopically displayed on a display means for stereoscopically displaying by performing a parallax adjustment on the plurality of images such that parallax becomes 0 at a position of a cross point, comprising:
parallax amount calculation means for calculating a parallax amount among the plurality of images for each subject within the images;
subject targeted for display position adjustment identifying means for identifying a subject as a subject targeted for display position adjustment, using a cross point provisionally set for the plurality of images as a reference in the case that a subject having an absolute parallax value which exceeds a predetermined amount is successively pictured in more than a predetermined number of frames; and
parallax adjustment means for adjusting parallax such that the absolute parallax value of the subject targeted for display position adjustment does not exceed a predetermined amount after adjustment.

2. The image processing apparatus as claimed in claim 1, wherein the predetermined amount is 2.9% of a screen width.

3. The image processing apparatus as claimed in claim 1, wherein the predetermined amount is 0.

4. The image processing apparatus as claimed in claim 1, wherein the predetermined number of frames is preferably no fewer than 3, nor more than 7.

5. The image processing apparatus as claimed in claim 2, wherein the predetermined number of frames is preferably no fewer than 3, nor more than 7.

6. The image processing apparatus as claimed in claim 3, wherein the predetermined number of frames is preferably no fewer than 3, nor more than 7.

7. The image processing apparatus as claimed in claim 4, wherein the predetermined number of frames is preferably 4 or 5.

8. The image processing apparatus as claimed in claim 5, wherein the predetermined number of frames is preferably 4 or 5.

9. The image processing apparatus as claimed in claim 6, wherein the predetermined number of frames is preferably 4 or 5.

10. The image processing apparatus as claimed in claim 1, further comprising:
image obtaining means for obtaining a plurality of images with different viewpoints;
movement detecting means for detecting movement of the image obtaining means; and
control means for prohibiting the parallax adjustment means from adjusting parallax while the movement of the image obtaining means is detected.

11. The image processing apparatus as claimed in claim 10, further comprising:
camera-shake detecting means for detecting a camera-shake amount of the image obtaining means,
wherein the camera-shake detecting means functions as the movement detecting means.

12. A image processing method for setting a predetermined point which corresponds to each of a plurality of images with different viewpoints, as a cross point and performing parallax adjustment on the plurality of images such that parallax becomes 0 at a position of the cross point so as to generate a stereoscopic image which is stereoscopically displayed on display means for stereoscopically displaying, the method comprising:
calculating a parallax amount among the plurality of images for each subject within the images;
identifying a subject as a subject targeted for display position adjustment, in a case where the subject having an absolute parallax value which exceeds a predetermined amount is successively pictured in more than a predetermined number of frames, using a cross point provisionally set for the plurality of images as a reference; and
adjusting parallax such that the absolute parallax value of the subject targeted for display position adjustment does not exceed a predetermined amount after adjustment.

13. The image processing method as claimed in claim 12, the method further comprising:
detecting movement of the image obtaining means when obtaining a plurality of image with different viewpoints by using the image obtaining means;
ceasing parallax adjustment while the movement of the image obtaining means is detected.
